(19) United States
(12) Patent Application Publication
(10) Pub. No.: US 2026/0342104 A1
(43) Pub. Date: Oct. 29, 2026

(54) POWER GENERATION CONTROL DEVICE

(71) Applicant: Chung-Chi Chou, Tainan City (TW)

(72) Inventor: Chung-Chi Chou, Tainan City (TW)

(21) Appl. No.: 19/643,600

(22) Filed: Apr. 9, 2026

(30) Foreign Application Priority Data
Apr. 29, 2025 (TW) 114116043

(51) Int. Cl. H02J 7/34; H02J 7/68; H02J 7/80; H02J 7/90; H02J 7/96; H02J 101/28

(52) U.S. Cl. CPC H02J 7/34; H02J 7/68; H02J 7/80; H02J 7/96; H02J 7/971; H02J 2101/28

(57) ABSTRACT

A power generation control device is provided. When the rotational speed detection signal provided by the first power interface is less than the rotational speed threshold, the power selection unit is controlled to receive the second power through the second input terminal by the power selection command. The charging current of the charging circuit is controlled to be less than the current of the working power. As a result, reducing the current of the generator (even to zero) leads to a decrease in the load torque. Consequently, a starting speed of the wind turbine connected to the power generation control device of the present disclosure is increased significantly. Also the wind turbine can start up under a lower wind speed, thereby increasing the annual power generation hours and enhancing the efficiency.

### CROSS-REFERENCE TO RELATED APPLICATION

This application claims priority to Taiwan Patent Application No. 114116043 filed on Apr. 29, 2025, the entire contents of which are incorporated herein by reference for all purposes.

### FIELD OF THE INVENTION

The present disclosure relates to power generation and more particularly to a power generation control device.

### BACKGROUND OF THE INVENTION

FIG. 1 is a schematic circuit diagram illustrating a conventional power generation control device used in wind or hydroelectric power generation. As shown in FIG. 1, a conventional power generation control device 1′ selectively receives two input sources, i.e., a generator 2′ and a battery 3′. The conventional power generation control device 1′ includes a rectifier 4′, DC bus 5′, a power selection unit 6′, a power supply unit 7′ and a control unit 8. The rectifier 4′ rectifies an AC power generated by the generator 2′ into a DC power and outputs the DC power to the DC bus 5′. The power selection unit 6′ includes two diodes 61′ and 62′ connected with each other in parallel. Two input terminals of the power selection unit 6′ are respectively connected to the DC bus 5′ and the battery 3′. Due to the characteristics of the diodes, the electrical energy provided by the input source with the higher voltage between the DC bus 5′ and the battery 3′ is output to the power supply unit 7′, and then the electrical energy is provided to the control unit 8. However, the power selection unit 6′ of the conventional power generation control device 1′ lacks flexibility by merely utilizing the two diodes 61′ and 62′, such that it only passively outputs the input source with the higher voltage. Consequently, the conventional power generation control device 1′ has adverse effects, and will be further described below.

FIG. 2 is a waveform diagram illustrating the torque and the tip speed ratio of a lift-type wind turbine. The vertical axis of FIG. 2 represents the torque output by the lift-type wind turbine. The horizontal axis of FIG. 2 represents the tip speed ratio of the lift-type wind turbine. The tip speed ratio is a ratio of a blade tip speed of the lift-type wind turbine (hereinafter referred to as a wind turbine) to a wind speed. For example, the tip speed ratio is 1. Namely, the blade tip speed is equal to the wind speed. The tip speed ratio is 2. Namely, the blade tip speed is twice of the wind speed. As shown in FIG. 2, when the tip speed ratio is ranged within 0 to 2, the torque output by the wind turbine approaches 0 and is not easy to self-start. Among them, the torque of a vertical-axis wind turbine is less than the torque of a horizontal-axis wind turbine, so that the vertical-axis wind turbine is more difficult to start up. Consequently, an additional auxiliary structure is required to increase the starting torque. For example, a chord length of a blade is widened, or a drag blade is added. However, the additional structure will reduce the efficiency of the wind turbine and can only be implemented in a limited extent. Consequently, the starting torque provided by the additional structure is limited. In particular, under a low wind speed condition, the wind turbine is more difficult to start.

In the conventional power generation control device, during the start-up stage of the wind turbine, a rotational speed of the generator 2′ is relatively low, such that the voltage of the DC bus 5′ is less than the voltage of the power provided by the battery 3′. Consequently, the power selection unit 6′ transmits the power provided by the battery 3′ to the power supply unit 7′ through the diode 62′. The generator 2′ does not output current. Accordingly, the generator 2′ does not generate a load torque, so that the wind turbine can accelerate smoothly. However, after the rotational speed of the wind turbine is increased, the output voltage of the generator 2′ is increased. Consequently, the voltage of the DC bus 5′ is greater than the voltage of the power provided by the battery 3′. Namely, the DC bus 5′ provides electrical energy to the power supply unit 7′, causing the generator 2′ to generate a load torque because of the output current. If the output torque of the wind turbine is insufficient to overcome the load torque of the generator 2′, the wind turbine cannot continue to accelerate. And thus a rotational speed sufficient for power generation cannot be reached. Consequently, before the wind turbine completes its start-up, the current generated by the generator 2′ must be minimized as much as possible, so that a rotational speed sufficient for power generation is achieved smoothly. Then, the power generation can be started.

In addition, when the wind speed is too low to increase the rotational speed of the wind turbine to generate power, or when the battery is fully charged and the wind turbine does not need to accelerate, the wind turbine rotates at a low speed. Consequently, the generator 2′ provides a relatively low voltage. The voltage of the DC bus 5′ is less than the voltage of the power provided by the battery 3′. So, the power supply unit 7′ is powered by the battery 3′ again. The battery 3′ consumes power continuously and causes the battery 3′ of the conventional power generation control device 1′ to have insufficient endurance.

Therefore, there is a need of providing a power generation control device to obviate the drawbacks encountered from the prior arts.

### SUMMARY OF THE INVENTION

The object of the present disclosure is to provide a power generation control device has advantage of enhancing efficiency and reducing power consumption of the battery.

In accordance with an aspect of the present disclosure, a power generation control device is provided. The power generation control device receives a first power provided by a generator and a second power provided by a battery. The power generation control device includes a power selection unit, a power supply unit, a first power interface, a second voltage detection unit, a charging circuit and a control unit. The power selection unit includes a first input terminal, a second input terminal and an output terminal. The power selection unit receives the first power through the first input terminal, receives the second power through the second input terminal, and selectively outputs the first power or the second power to a working power through the output terminal. The power supply unit is connected to the output terminal of the power selection unit to receive and convert the working power into a fixed voltage. The first power interface is connected between the generator and the first input terminal of the power selection unit to detect an electrical characteristic of the first power provided by the generator and output a rotational speed detection signal. The second voltage detection unit is configured to detect a voltage of the second power at the second input terminal of the power selection unit and output a second voltage signal. The charging circuit is configured to receive the first power to generate a charging current to charge the second power. The control unit is configured to be driven by the fixed voltage and output a power selection command to the power selection unit, thereby controls the output terminal of the power selection unit to be conducted to the first input terminal or the second input terminal so as to control a source of the working power, and outputs a charging command to the charging circuit to control a magnitude of the charging current of the charging circuit. When the rotational speed detection signal is less than a rotational speed threshold, the control unit is configured to control the output terminal of the power selection unit to be conducted to the second input terminal by the power selection command, so that the second power is served as the source of the working power. The control unit is also configured to control the charging current of the charging circuit to be less than a current of the working power by the charging command.

In accordance with another aspect of the present disclosure, a power generation control device is provided. The power generation control device receives a first power provided by a generator and a second power provided by a battery. The power generation control device includes a power selection unit, a power supply unit, a first power interface, a charging circuit, a battery detection circuit and a control unit. The power selection unit includes a first input terminal, a second input terminal and an output terminal. The power selection unit receives the first power through the first input terminal, receives the second power through the second input terminal, and selectively outputs the first power or the second power to a working power through the output terminal. The power supply unit is connected to the output terminal of the power selection unit to receive and convert the working power into a fixed voltage. The first power interface is connected between the generator and the first input terminal of the power selection unit to detect an electrical characteristic of the first power provided by the generator and output a rotational speed detection signal. The charging circuit is configured to receive the first power to generate a charging current to charge the second power. The battery detection circuit is disposed between the battery and the charging circuit to detect whether the battery is connected to the power generation control device normally and to output a detection signal. When the rotational speed detection signal is less than a rotational speed threshold, the control unit is configured to execute a startup procedure. The startup procedure includes the following steps. Whether the battery is connected to the power generation control device normally is determined according to the detection signal. If the battery is not connected to the power generation control device normally, the power generation control device exits the startup procedure. If the battery is connected to the power generation control device normally, the power generation control device operates in a low power consumption mode, and wait for a preset time. Subsequently, the power generation control device operates in a normal mode to verify whether the rotational speed detection signal is greater than or equal to a rotational speed threshold. If the rotational speed detection signal is not greater than or equal to a rotational speed threshold, the power generation control device returns to a low power consumption mode, and wait for a preset time again. If the rotational speed detection signal is greater than or equal to a rotational speed threshold, the power generation control device starts executing a power generation procedure.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a conventional power generation control device used in wind or hydroelectric power generation;

FIG. 2 is a waveform diagram illustrating the torque and the tip speed ratio of a lift-type wind turbine;

FIG. 3 is a schematic circuit diagram illustrating a power generation control device according to a first embodiment of the present disclosure;

FIG. 4 is a schematic circuit diagram illustrating a power generation control device according to a second embodiment of the present disclosure;

FIG. 5 is a flowchart illustrating a control method of a control unit of the power generation control device of FIG. 4;

FIG. 6A is a schematic circuit diagram illustrating a second embodiment of the power selection unit of the power generation control device according to the present disclosure;

FIG. 6B is a schematic circuit diagram illustrating a third embodiment of the power selection unit of the power generation control device according to the present disclosure;

FIG. 7A is a schematic circuit diagram illustrating a fourth embodiment of the power selection unit of the power generation control device according to the present disclosure; and

FIG. 7B is a schematic circuit diagram illustrating a fifth embodiment of the power selection unit of the power generation control device according to the present disclosure.

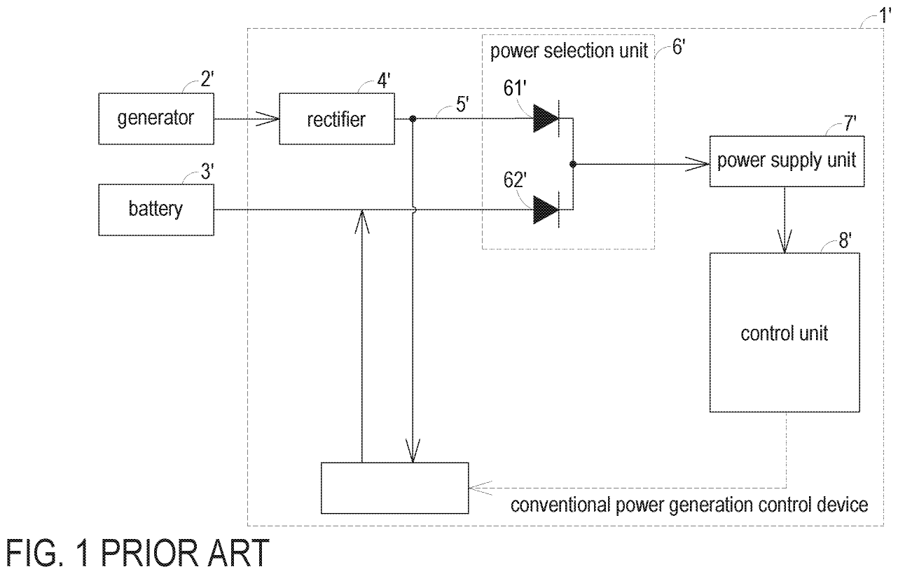

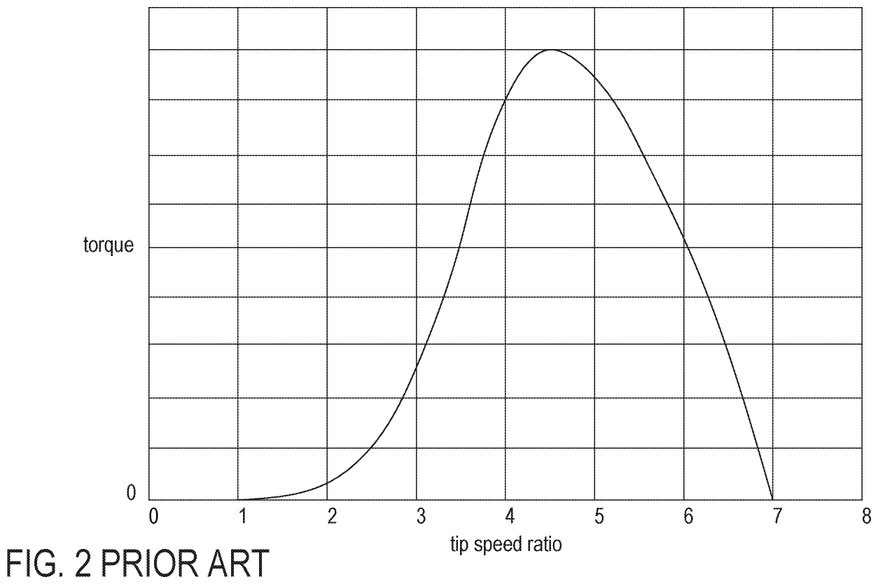

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

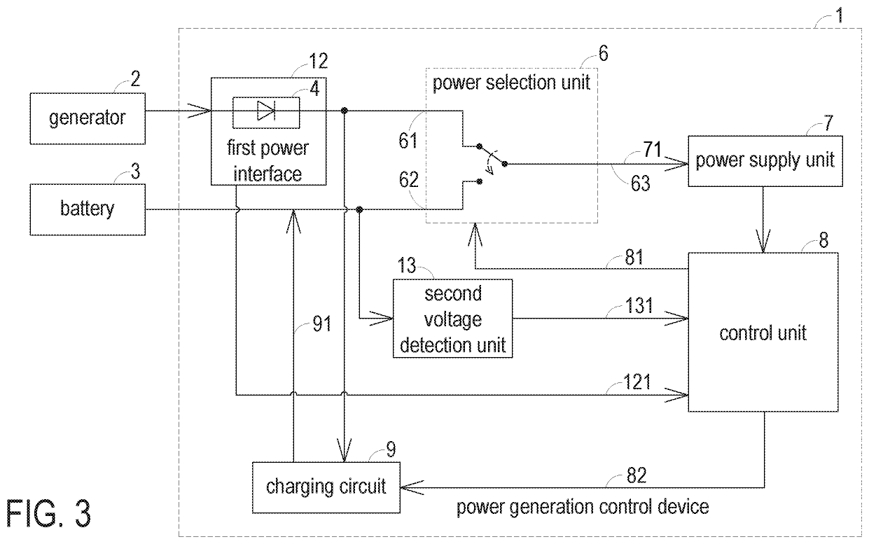

FIG. 3 is a schematic circuit diagram illustrating a power generation control device according to a first embodiment of the present disclosure. As shown in FIG. 3, the power generation control device 1 of this embodiment is connected to a generator 2 and a battery 3 and receives a first power provided by the generator 2 and a second power provided by the battery 3. The generator 2 is connected to a wind turbine or a water turbine (not shown in figure). For example, the generator 2 is connected to the wind turbine. When the wind turbine is rotated, it drives the generator 2 to be rotated. Namely, a rotational speed of the wind turbine is correlated with electrical characteristics (i.e., voltage or frequency) of the first power provided by the generator 2. In this embodiment, the first power provided by the generator 2 is an AC power. Certainly, in some embodiments, the first power provided by the generator 2 can be a DC power.

The power generation control device 1 includes a power selection unit 6, a power supply unit 7, a first power interface 12, a second voltage detection unit 13, a charging circuit 9 and a control unit 8. The first power interface 12 is connected between the generator 2 and a first input terminal 61 of the power selection unit 6. In this embodiment, the first power interface 12 includes a rectifier 4 for converting the first power from the AC power into the DC power (i.e., a DC bus). Certainly, in some embodiments, when the first power provided by the generator 2 is the DC power, the rectifier is not required. In addition, the first power interface 12 detects the electrical characteristics of the first power provided by the generator 2, such as voltage or frequency, as the rotational speed information of the generator 2, and outputs it to the control unit 8 through a rotational speed detection signal 121. The power selection unit 6 is a three-port device and includes the first input terminal 61, a second input terminal 62 and an output terminal 63. The first input terminal 61 is connected to an output terminal of the first power interface 12, so that the power selection unit 6 receives the first power in the form of the DC power through the first input terminal 61. The second input terminal 62 is connected to the battery 3, so that the power selection unit 6 receives the second power through the second input terminal 62. The output terminal 63 is selectively conducted to the first input terminal 61 or the second input terminal 62. Consequently, the power selection unit 6 selectively outputs the first power or the second power to a working power 71 through the output terminal 63. The power supply unit 7 is connected to the output terminal 63 of the power selection unit 6 to receive and convert the working power 71 into a fixed voltage. The fixed voltage may be 12V, 5V, 3.3V, or 1.8V, and usually includes a combination of multiple voltages.

The second voltage detection unit 13 is connected to the second input terminal 62 of the power selection unit 6 to detect a voltage of the second power provided by the battery 3 at the second input terminal 62 of the power selection unit 6, and output a second voltage signal 131. The charging circuit 9 is connected between the first input terminal 61 and the second input terminal 62 of the power selection unit 6 to receive the first power in the form of the DC power converted by the rectifier 4 so as to generate a charging current 91 to charge the second power provided by the battery 3.

The control unit 8 is connected to the power supply unit 7, the first power interface 12, the second voltage detection unit 13, the power selection unit 6 and the charging circuit 9. The control unit 8 includes a preset rotational speed threshold.

The control unit 8 is driven by the fixed voltage provided by the power supply unit 7. The control unit 8 receives the rotational speed detection signal 121 provided by the first power interface 12 and the second voltage signal 131 provided by the second voltage detection unit 13, and outputs a power selection command 81 to the power selection unit 6, thereby controls the output terminal 63 of the power selection unit 6 to be conducted to the first input terminal 61 or the second input terminal 62, and thus controls a source of the working power 71. The control unit 8 further outputs a charging command 82 to the charging circuit 9 to control the magnitude of the charging current 91 of the charging circuit 9. In an embodiment, the charging command 82 is a pulse width modulation (PWM) signal to control a transistor disposed in the charging circuit 9 so as to regulate the charging current 91.

When a rotational speed of the generator 2 is increased, the voltage of the first power in the form of the DC power converted by the rectifier 4 (i.e., the DC bus) is increased. The first power interface 12 detects the voltage of the first power in the form of the DC power to obtain the rotational speed of the wind turbine connected to the generator 2, and outputs it to the control unit 8 through the rotational speed detection signal 121. Moreover, the relationship between the rotational speed of the generator 2 and a frequency of the first power in the form of the AC power is shown as: V=120×F/P. V is represented as the rotational speed of the generator 2 in RPM (revolutions per minute). F is represented as the frequency of the first power in the form of the AC power in Hz. P is represented as a number of magnetic poles of the generator 2. P is a known parameter. Consequently, the first power interface 12 only need to detect the frequency (F) of the first power in the form of the AC power. By applying the above relationship, the rotational speed (V) of the generator 2 can be calculated. In an embodiment, a frequency-to-voltage conversion circuit can be used to convert the frequency of the first power into a voltage signal. In another embodiment, a sine wave of the AC power is converted into a square wave signal, which is then output to the control unit 8 through the rotational speed detection signal 121. The control unit 8 may count a number of square waves within a unit time to obtain the frequency (F) of the first power, and thereby calculate the rotational speed (V) of the generator 2.

When the rotational speed detection signal 121 is less than the rotational speed threshold, the control unit 8 determines that the wind turbine is in a start-up stage, the output terminal 63 of the power selection unit 6 is conducted to the second input terminal 62 by the power selection command 81. Namely, the source of the working power 71 is the second power received by the second input terminal 62, thus the generator 2 is not required to supply power. The charging current 91 of the charging circuit 9 is controlled by the charging command 82. From above, the charging current 91 is provided from the first power of the generator 2. When the charging current 91 is equal to 0, this is the optimal case, resulting in the generator 2 generating no load torque because of no current, thereby the wind turbine can start and accelerate easily. However, at this time, the working power 71 is completely provided by the battery 3 (i.e., the second power). If the battery 3 does not has sufficient capacity, a voltage of the battery 3 may drop to lead a risk of over-discharge that may damage a lifespan of the battery 3. If the battery is a lithium battery, a low voltage protection may be triggered, so that the battery 3 cannot supply power. At this time, the charging circuit 9 may be controlled to generate an appropriate charging current 91 to the second power to supply a portion of the working power 71, thereby reducing the burden on the battery 3, and preventing the voltage of the battery 3 from being too low. A current of the working power 71 is abbreviated as IW, and its value is determined by a consumption current of the power supply unit 7. When the charging current 91 is set to 0.1 IW, the battery only needs to provide the remaining 0.9 IW. When the charging current 91 is set to 0.3 IW, the battery provides the remaining 0.7 IW, and so on. Consequently, by adjusting the magnitude of the charging current 91, the working power 71 is provided from any proportional combination of the first power and the second power, rather than being limited to an exclusive selection of either the first power or the second power, thus increasing the operational flexibility. The balance between start-up performance and protection of the battery can be achieved, which represents one of the inventive improvements of the present disclosure. Moreover, when the charging current 91 is greater than or equal to IW, it represents that the working power 71 is completely provided from the first power provided by the generator 2 and the additional current will flow into the battery 3 to charge the battery 3. In this case, it is equivalent to the output terminal 63 of the power selection unit 6 being conducted to the first input terminal 61, which contradicts the condition of the present invention (i.e., the output terminal 63 being conducted to the second input terminal 62), and thus falls outside the scope of the invention. Consequently, in this embodiment, the charging current 91 is less than the current IW of the working power 71.

From above, when the rotational speed detection signal 121 provided by the first power interface 12 is less than the rotational speed threshold, the control unit 8 of the power generation control device 1 of the present disclosure determines that it is in the start-up stage. To control the output terminal 63 of the power selection unit 6 to be conducted to the second input terminal 62 by the power selection command 81. Namely, the source of the working power 71 is the second power received by the second input terminal 62. Meanwhile, controls the charging current 91 of the charging circuit 9 to be less than the current of the working power 71. As a result, reducing of the current of the generator 2 (even to zero) leads to a decrease in the load torque. Consequently, a starting speed of the wind turbine connected to the power generation control device 1 of the present disclosure is increased significantly. Also, the wind turbine can start up under a lower wind speed, thereby increasing the annual power generation hours and enhancing the efficiency.

In some embodiments, when the wind speed is too low for the wind turbine to increase the rotational speed required for power generation, or when the battery 3 is fully charged, resulting in a lower rotational speed of the wind turbine, thus the voltage of the first power provided by the generator 2 connected to the wind turbine is also low, causing the working power 71 is provided from the battery 3. For preventing excessive consumption of electrical energy of the battery 3, the generator 2 may be utilized to supply power by controlling the power selection unit 6. In this embodiment, the control unit 8 further includes a second voltage threshold. When the second voltage signal 131 provided by the second voltage detection unit 13 is greater than or equal to the second voltage threshold, the control unit 8 confirms that the battery 3 has been fully charged, At this time, the output terminal 63 of the power selection unit 6 is controlled to be conducted to the first input terminal 61 by the power selection command 81, so that the first power received by the first input terminal 61 is served as the source of the working power 71 without consuming electrical energy of the battery 3.

In the first embodiment, the battery is utilized to provide power during the start-up stage. However, if the electrical energy of the battery has been exhausted or a circuit breaker in the battery has tripped and is not connected to the power generation control device normally, resulting in the battery being unable to supply power, the method of the first embodiment cannot be utilized. When the voltage of the battery 3 is sufficient, it indicates that the battery 3 is connected to the power generation control device normally, and therefore the wind turbine can be started to drive the generator 2 to charge the battery 3. However, when the voltage of the battery 3 is insufficient, that means the electrical energy of the battery 3 has been exhausted or the battery 3 is not connected to the power generation control device normally. If the electrical energy has been exhausted, the battery 3 can be charged. If the battery 3 is not connected to the power generation control device normally, the battery 3 cannot be charged. Consequently, it is not possible to determine whether the battery 3 is normally connected to the power generation control device merely by detecting the voltage of the battery 3.

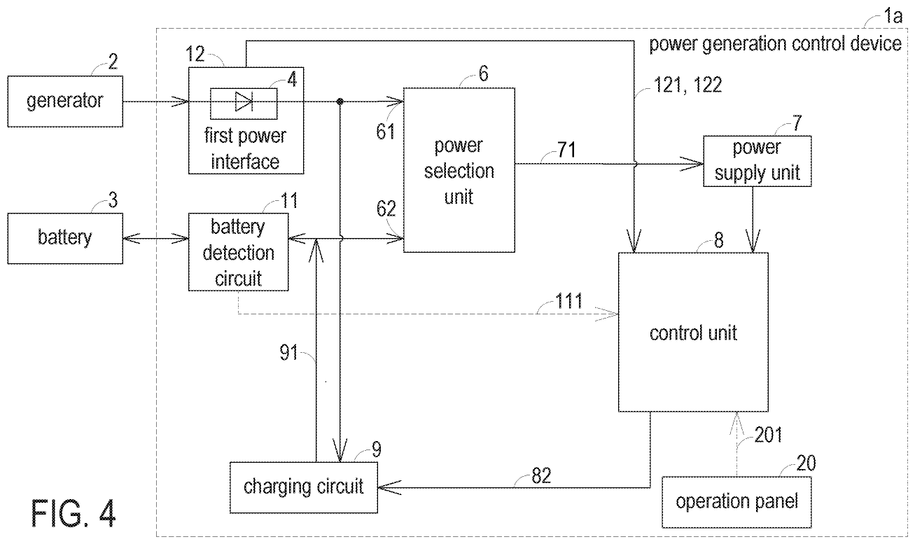

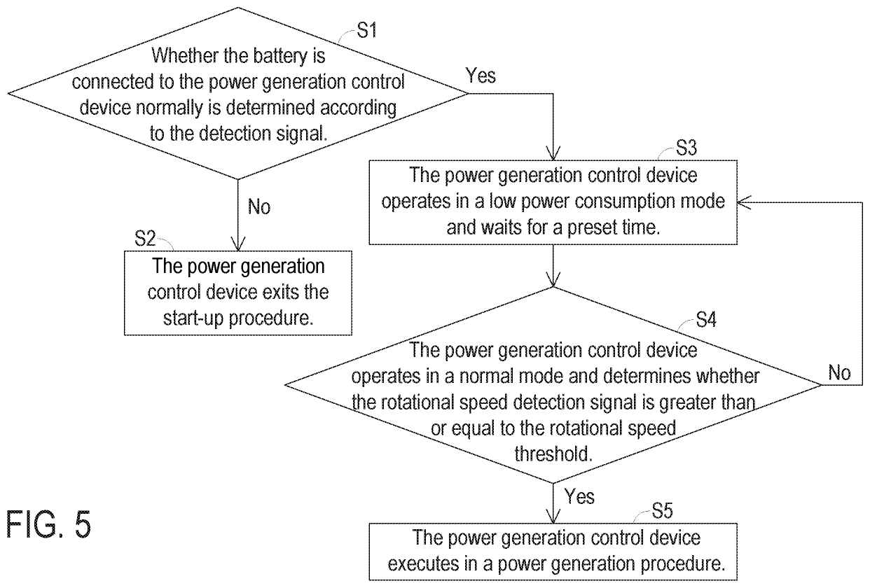

FIG. 4 is a schematic circuit diagram illustrating a power generation control device according to a second embodiment of the present disclosure. FIG. 5 is a flowchart illustrating a control method of a control unit of the power generation control device of FIG. 4. As shown in FIG. 4, compared with the power generation control device 1 of FIG. 3, the power generation control device 1a of this embodiment further includes a battery detection circuit 11 located between the battery 3 and the charging circuit 9, which replaces the second voltage detection unit 13 of the power generation control device 1. The battery detection circuit 11 is configured to detect whether the battery 3 is connected to the power generation control device 1a normally. A brief charging of the battery 3 can be performed through the charging circuit 9. If the battery 3 is connected to the power generation control device 1a normally, a current will flow through the battery detection circuit 11. The battery detection circuit 11 detects the current (for example, by detecting a voltage variation caused by the current), and transmits a detection result to the control unit 8 by a detection signal 111. The control unit 8 includes a control chip and a peripheral circuit (not shown in figure). The control unit 8 determines whether the battery 3 is connected to the power generation control device 1a normally according to the detection signal 111, and can control the power generation control device 1a to operate in a low power consumption mode or a normal mode. When the control unit 8 controls the power generation control device 1a to operate in the low power consumption mode, the control unit 8 turns off at least part of functions in the power generation control device 1a, such as turning off communication functions, controlling the control chip to enter a sleep mode, turning off power of the peripheral circuit, cutting off the charging current 91, or turning off a backlight of a display screen. When the control unit 8 controls the power generation control device 1a to operate in the normal mode, the control unit 8 controls most functions in the power generation control device 1a to operate normally. Consequently, the power consumption in the low power consumption mode is less than the power consumption in the normal mode.

In this embodiment, when the rotational speed detection signal 121 is less than the rotational speed threshold, it is determined to be the start-up stage. The control unit 8 is configured to execute the following start-up procedure. As shown in FIG. 5, first, a step S1 is performed. In the step S1, whether the battery 3 is connected to the power generation control device 1a normally is determined according to the detection signal 111. If a determination result of the step S1 is not satisfied, a step S2 is performed. In the step S2, the power generation control device 1a exits the start-up procedure. If the determination result of the step S1 is satisfied, namely, the battery 3 is connected to the power generation control device 1a normally, a step S3 is performed. In the step S3, the power generation control device 1a operates in a low power consumption mode to reduce the current of the generator 2, and waits for a preset time so as to allow the wind turbine to start up and accelerate. After the step S3 is performed, a step S4 is performed. In the step S4, the power generation control device 1a operates in a normal mode and determines whether the rotational speed detection signal 121 is greater than or equal to the rotational speed threshold. If the determination result of the step S4 is not satisfied, namely, the rotational speed detection signal 121 is less than the rotational speed threshold, the power generation control device 1a is still in the start-up stage, and the step S3 is performed again. If the determination result of the step S4 is satisfied, namely, the rotational speed detection signal 121 is greater than or equal to the rotational speed threshold, the rotational speed of the wind turbine is sufficient, a step S5 is performed. In the step S5, the power generation control device 1a executes in a power generation procedure. In this embodiment, regardless of whether the battery 3 has electrical energy, the current generated by the generator 2 is reduced by the low power consumption mode of the power generation control device 1a. thereby, the load torque during start-up of the wind turbine is reduced, and the wind turbine can be started easily. Consequently, in this embodiment, the power selection unit 6 may, but is not necessarily, the same as the power selection unit 6 of the first embodiment.

Moreover, during a windless season, the battery 3 cannot be charged, and the electrical energy of the battery 3 is exhausted easily. In such case, the power generation control device 1a may operate in the low power consumption mode to save electrical energy of the battery 3. The power generation control device 1a may be awakened automatically by a timer or an external signal. Please refer to FIG. 4 again. In this embodiment, when the voltage of the first power at the first input terminal 61 of the power selection unit 6 detected by the first power interface 12 is greater than a first voltage threshold, namely, the wind turbine connected to the generator 2 has reached a certain rotational speed, the first power interface 12 additionally outputs a wake-up signal 122 to the control unit 8, such that the power generation control device 1a return from the low power consumption mode to the normal mode. The first voltage threshold is the voltage of the first input terminal 61 of the power selection unit 6 (i.e., the voltage of the DC bus), which represents the minimum voltage required for the power supply unit 7 to generate sufficient power to drive the control unit 8.

In this embodiment, the power generation control device 1a further includes an operation panel 20. The operation panel 20 is connected to the control unit 8 and includes a button or a touch point (not shown in figure). The operation panel 20 may generate a forced wake-up signal 201 to the control unit 8 by user operation, such that the power generation control device 1a returns from the low power consumption mode to the normal mode to facilitate testing and maintenance.

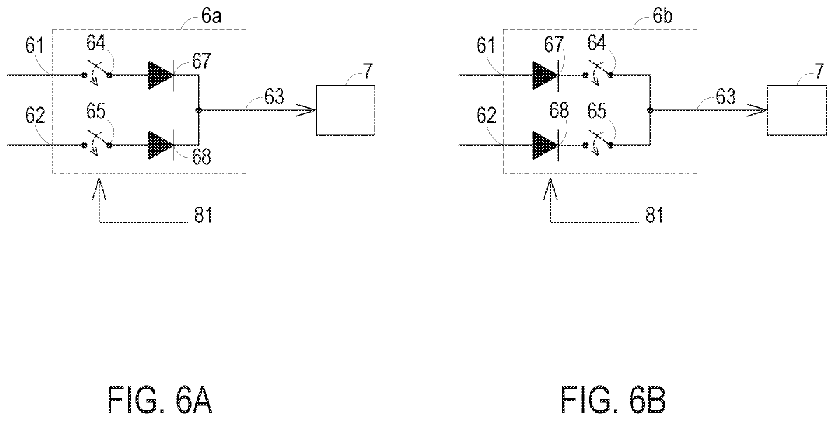

In some embodiments, the structure of the power selection unit may be adjusted according to requirements. FIG. 6A is a schematic circuit diagram illustrating a second embodiment of the power selection unit of the power generation control device according to the present disclosure. The power selection unit 6 of the power generation control device 1 of FIG. 3 is a three-port device. Compared with the power selection unit 6 of the power generation control device 1 of FIG. 3, as shown in FIG. 6A, the power selection unit 6a of this embodiment includes a first switch 64, a second switch 65, a first diode 67 and a second diode 68. The first switch 64 is connected to the first input terminal 61 of the power selection unit 6a. An anode of the first diode 67 is connected to the first switch 64. A cathode of the first diode 67 is connected to the output terminal 63 of the power selection unit 6a. The second switch 65 is connected to the second input terminal 62 of the power selection unit 6a. An anode of the second diode 68 is connected to the second switch 65. A cathode of the second diode 68 is connected to the output terminal 63 of the power selection unit 6a. FIG. 6B is a schematic circuit diagram illustrating a third embodiment of the power selection unit of the power generation control device according to the present disclosure. Compared with the power selection unit 6a of FIG. 6A, as shown in FIG. 6B, the anode of the first diode 67 of this embodiment is connected to the first input terminal 61 of the power selection unit 6b. The first switch 64 is connected between the cathode of the first diode 67 and the output terminal 63 of the power selection unit 6b. The anode of the second diode 68 is connected to the second input terminal 62 of the power selection unit 6b. The second switch 65 is connected between the cathode of the second diode 68 and the output terminal 63 of the power selection unit 6b.

In the embodiments of FIG. 6A and FIG. 6B, the first switch 64 and the second switch 65 of the power selection units 6a and 6b are but not limited to relays, optocouplers, bipolar junction transistors (BJT) or metal-oxide-semiconductor field-effect transistors (MOSFET). The first switch 64 and the second switch 65 are both in a conducted state in an initial state. For example, the first switch 64 and the second switch 65 are conducted before the control unit 8 receives the fixed voltage provided by the power supply unit 7 and is able to control the power selection unit 6a and 6b. After the power supply unit 7 provides the fixed voltage to enable the control unit 8 to start operating, the control unit 8 outputs the power selection command 81 to control the first switch 64 and the second switch 65 of the power selection unit 6a and 6b, thereby selecting the source of the output terminal 63 from the first power connected to the first input terminal 61 or the second power connected to the second input terminal 62. The control method is similar to the previous embodiments, and is not redundantly described hereinafter.

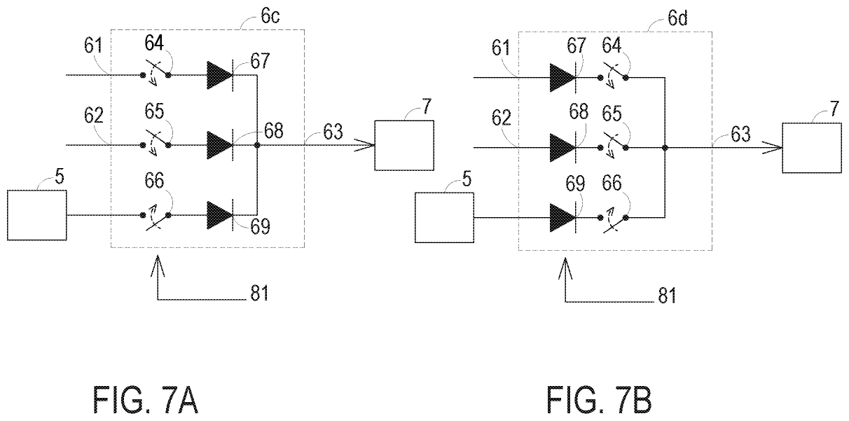

FIG. 7A is a schematic circuit diagram illustrating a fourth embodiment of the power selection unit of the power generation control device according to the present disclosure. Compared with the power selection unit 6a of FIG. 6A, as shown in FIG. 7A, the power selection unit 6c of this embodiment further includes a third switch 66 and a third diode 69. The third switch 66 is connected to an auxiliary power source 5 external to the power generation control device, such as a solar panel. An anode of the third diode 69 is connected to the third switch 66. A cathode of the third diode 69 is connected to the output terminal 63 of the power selection unit 6c. FIG. 7B is a schematic circuit diagram illustrating a fifth embodiment of the power selection unit of the power generation control device according to the present disclosure. Compared with the power selection unit 6b shown in FIG. 6B, as shown in FIG. 7B, the power selection unit 6d of this embodiment further includes the third switch 66 and the third diode 69. An anode of the third diode 69 is connected to the auxiliary power source 5 external to the power generation control device. The third switch 66 is connected between a cathode of the third diode 69 and the output terminal 63 of the power selection unit 6d.

In the embodiments of FIG. 7A and FIG. 7B, the first switch 64, the second switch 65, and the third switch 66 of the power selection units 6c and 6d are all in a conducted state in an initial state. For example, the first switch 64, the second switch 65, and the third switch 66 are conducted before the control unit 8 receives the fixed voltage provided by the power supply unit 7 and is able to control the power selection units 6c and 6d. After the power supply unit 7 provides the fixed voltage to enable the control unit 8 to start operating, the control unit 8 outputs the power selection command 81 to control the first switch 64, the second switch 65 and the third switch 66 of the power selection units 6c and 6d, thereby selecting the source of the output terminal 63 from the first power connected to the first input terminal 61, the second power connected to the second input terminal 62, or another power provided by the auxiliary power source 5. The control method is similar to the previous embodiments, and is not redundantly described hereinafter.

From the above descriptions, when the rotational speed detection signal provided by the first power interface is less than the rotational speed threshold, the power selection unit is controlled to receive the second power through the second input terminal by the power selection command, and the charging current of the charging circuit is controlled to be less than the current of the working power. As a result, reducing the current of the generator (even to zero) leads to a decrease in the load torque. Consequently, a starting speed of the wind turbine connected to the power generation control device of the present disclosure is increased significantly. The wind turbine can also start up under a lower wind speed, thereby increasing the annual power generation hours and enhancing the efficiency. The source of the working power may also be adjusted to any proportional combination of the first power and the second power to balance start-up performance and protection of the battery. Moreover, when electrical energy of the battery is exhausted, the current generated by the generator can be reduced by the low power consumption mode of the power generation control device of the present disclosure, thereby reducing the load torque during start-up of the wind turbine connected to the power generation control device and enabling the wind turbine to start-up smoothly and proceed with power generation. Furthermore, the power consumption of the battery is reduced and the standby time is increased by the low power consumption mode. Consequently, the power generation control device of the present disclosure has improving endurance and reducing maintenance frequency for unattended power generation stations in remote areas, such as signal stations or lighthouses located in high mountain or sea.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power generation control device, receiving a first power provided by a generator and a second power provided by a battery, and the power generation control device comprising:
a power selection unit comprising a first input terminal, a second input terminal and an output terminal, wherein the power selection unit receives the first power through the first input terminal, receives the second power through the second input terminal, and selectively outputs the first power or the second power to a working power through the output terminal;
a power supply unit connected to the output terminal of the power selection unit to receive and convert the working power into a fixed voltage;
a first power interface connected between the generator and the first input terminal of the power selection unit to detect an electrical characteristic of the first power provided by the generator and output a rotational speed detection signal;
a second voltage detection unit configured to detect a voltage of the second power at the second input terminal of the power selection unit and output a second voltage signal;
a charging circuit configured to receive the first power to generate a charging current to charge the second power; and
a control unit configured to be driven by the fixed voltage and output a power selection command to the power selection unit, wherein the output terminal of the power selection unit is controlled to be conducted to the first input terminal or the second input terminal so as to control a source of the working power, and outputs a charging command to the charging circuit to control a magnitude of the charging current of the charging circuit;
wherein when the rotational speed detection signal is less than a rotational speed threshold, the control unit is configured to control the output terminal of the power selection unit to be conducted to the second input terminal by the power selection command, so that the second power is served as the source of the working power, and the control unit is configured to control the charging current of the charging circuit to be less than a current of the working power by the charging command.

2. The power generation control device according to claim 1, wherein the first power provided by the generator is AC power, the first power interface further comprises a rectifier, and the rectifier is configured to convert the first power in a form of AC power into the first power in a form of DC power to be provided to the power selection unit.

3. The power generation control device according to claim 1, wherein the control unit further comprises a second voltage threshold, wherein when the second voltage signal is greater than or equal to the second voltage threshold, the control unit is configured to control the output terminal of the power selection unit to be conducted to the first input terminal by the power selection command, so that the first power is served as the source of the working power.

4. The power generation control device according to claim 1, wherein the power selection unit comprises a first switch, a second switch, a first diode and a second diode, the first switch is connected to the first input terminal of the power selection unit, an anode of the first diode is connected to the first switch, a cathode of the first diode is connected to the output terminal of the power selection unit, the second switch is connected to the second input terminal of the power selection unit, an anode of the second diode is connected to the second switch, and a cathode of the second diode is connected to the output terminal of the power selection unit.

5. The power generation control device according to claim 4, wherein the power selection unit further comprises a third switch and a third diode, the third switch is connected to an auxiliary power source, an anode of the third diode is connected to the third switch, and a cathode of the third diode is connected to the output terminal of the power selection unit.

6. The power generation control device according to claim 4, wherein the first switch and the second switch are relays, optocouplers, bipolar junction transistors or metal-oxide-semiconductor field-effect transistors.

7. The power generation control device according to claim 1, wherein the power selection unit comprises a first switch, a second switch, a first diode and a second diode, an anode of the first diode is connected to the first input terminal of the power selection unit, the first switch is connected between a cathode of the first diode and the output terminal of the power selection unit, an anode of the second diode is connected to the second input terminal of the power selection unit, the second switch is connected between a cathode of the second diode and the output terminal of the power selection unit.

8. The power generation control device according to claim 7, wherein the first switch and the second switch are relays, optocouplers, bipolar junction transistors or metal-oxide-semiconductor field-effect transistors.

9. The power generation control device according to claim 1, wherein the first power interface is configured to detect a voltage of the first power in the form of DC power, and outputs the voltage to the control unit through the rotational speed detection signal.

10. The power generation control device according to claim 1, wherein the first power interface is configured to detect a frequency of the first power in the form of AC power as a rotational speed information of the generator.

11. A power generation control device, receiving a first power provided by a generator and a second power provided by a battery, and the power generation control device comprising:
a power selection unit comprising a first input terminal, a second input terminal and an output terminal, wherein the power selection unit receives the first power through the first input terminal, receives the second power through the second input terminal, and selectively outputs the first power or the second power to a working power through the output terminal;
a power supply unit connected to the output terminal of the power selection unit to receive and convert the working power into a fixed voltage;
a first power interface connected between the generator and the first input terminal of the power selection unit to detect an electrical characteristic of the first power provided by the generator and output a rotational speed detection signal;
a charging circuit configured to receive the first power to generate a charging current to charge the second power;
a battery detection circuit disposed between the battery and the charging circuit to detect whether the battery is connected to the power generation control device normally, and configured to output a detection signal; and
a control unit, wherein when the rotational speed detection signal is less than a rotational speed threshold, the control unit is configured to execute a startup procedure, and the startup procedure comprises the following steps:
(a) determining whether the battery is connected to the power generation control device normally according to the detection signal;
(b) if a determination result of the step (a) is not satisfied, executing the power generation control device to exit the startup procedure;
(c) if the determination result of step (a) is satisfied, executing the power generation control device in a low power consumption mode and waiting for a preset time;
(d) executing the power generation control device in a normal mode, and determining whether the rotational speed detection signal is greater than or equal to a rotational speed threshold;
(e) if a determination result of the step (d) is not satisfied, performing the step (c) again; and
(f) if the determination result of step (d) is satisfied, executing the power generation control device in a power generation procedure.

12. The power generation control device according to claim 11, wherein the battery detection circuit is configured to detect a current flowing through the battery detection circuit when the charging circuit charges the battery briefly, and transmit a detection result to the control unit by the detection signal.

13. The power generation control device according to claim 11, wherein when the control unit is configured to control the power generation control device to operate in the low power consumption mode, the control unit turns off communication functions, controls a control chip to enter a sleep mode, cuts off the charging current, or turns off a backlight of a display screen.

14. The power generation control device according to claim 11, wherein when a voltage of the first power detected by the first power interface is greater than a first voltage threshold, the first power interface is configured to additionally output a wake-up signal to the control unit, so that the power generation control device returns from the low power consumption mode to the normal mode.

15. The power generation control device according to claim 11, wherein the power generation control device further comprises an operation panel, the operation panel is configured to generate a forced wake-up signal to the control unit by user operation, so that the power generation control device returns from the low power consumption mode to the normal mode.

16. The power generation control device according to claim 11, wherein the power selection unit comprises a first switch, a second switch, a first diode and a second diode, the first switch is connected to the first input terminal of the power selection unit, an anode of the first diode is connected to the first switch, a cathode of the first diode is connected to the output terminal of the power selection unit, the second switch is connected to the second input terminal of the power selection unit, an anode of the second diode is connected to the second switch, and a cathode of the second diode is connected to the output terminal of the power selection unit.

17. The power generation control device according to claim 16, wherein the first switch and the second switch are relays, optocouplers, bipolar junction transistors or metal-oxide-semiconductor field-effect transistors.

18. The power generation control device according to claim 11, wherein the power selection unit comprises a first switch, a second switch, a first diode and a second diode, an anode of the first diode is connected to the first input terminal of the power selection unit, the first switch is connected between a cathode of the first diode and the output terminal of the power selection unit, an anode of the second diode is connected to the second input terminal of the power selection unit, the second switch is connected between a cathode of the second diode and the output terminal of the power selection unit.

19. The power generation control device according to claim 11, wherein the first power interface is configured to detect a voltage of the first power in the form of DC power, and outputs the voltage to the control unit through the rotational speed detection signal.

20. The power generation control device according to claim 11, wherein the first power interface is configured to detect a frequency of the first power in the form of AC power as a rotational speed information of the generator.
